(19) United States
(12) Patent Application Publication
(10) Pub. No.: US 2023/0035637 A1
(43) Pub. Date: Feb. 2, 2023

(54) VEHICLE STATE ESTIMATION SYSTEMS AND METHODS

(71) Applicant: GM GLOBAL TECHNOLOGY OPERATIONS LLC, Detroit, MI (US)

(72) Inventors: Nikolai K Moshchuk, Grosse Pointe Farms, MI (US); David Perez-Chaparro, Ferndale, MI (US); Kausalya Singuru, Troy, MI (US); Hualin Tan, Novi, MI (US); Jin-Jae Chen, Canton, MI (US); Mohammadali Shahriari, Markham (CA); Ping Mi, Novi, MI (US); Jimmy Lu, Markham (CA)

(73) Assignee: GM GLOBAL TECHNOLOGY OPERATIONS LLC, Detroit, MI (US)

(21) Appl. No.: 17/444,005

(22) Filed: Jul. 29, 2021

(51) Int. Cl. B60W 60/00

(52) U.S. Cl. CPC B60W 60/001; B60W 2420/42; B60W 2552/53; B60W 2520/14; B60W 2520/105; B60W 2520/125

(57) ABSTRACT

Methods and systems are provided for controlling an autonomous vehicle. In one embodiment, a method includes: A method of controlling an autonomous vehicle, comprising: receiving, by a processor, a first set of data obtained from an inertial measurement unit of the vehicle; receiving, by the processor, a second set of data obtained from a global positioning system of the vehicle; receiving, by the processor, a third set of data obtained from a camera of the vehicle; determining, by the processor, at least two vehicle states relative to markings of a lane by processing the first set of data, the second set of data, and the third set of data as measurement with an extended Kalman filter; and controlling, by the processor, the vehicle based on the at least two vehicle states.

### INTRODUCTION

The technical field generally relates to methods and systems for controlling a vehicle, and more particularly relates to methods and systems for estimating vehicle states using global positioning system (GPS) data and camera data.

Vehicle control systems rely on accurate vehicle state data in order to make decisions about controlling the vehicle. Trailer applications require vehicle estimations in order to control the vehicle and/or trailer when trailering. Some vehicle systems estimate vehicle kinematics using a vehicle dynamics model such as a bicycle model that evaluates tire or wheel speed data.

Accordingly, it is desirable to provide improved methods and systems for estimating vehicle states using of forms of data such as GPS data and camera data. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for controlling an autonomous vehicle. In one embodiment, a method includes: A method of controlling an autonomous vehicle, comprising: receiving, by a processor, a first set of data obtained from an inertial measurement unit of the vehicle; receiving, by the processor, a second set of data obtained from a global positioning system of the vehicle; receiving, by the processor, a third set of data obtained from a camera of the vehicle; determining, by the processor, at least two vehicle states relative to markings of a lane by processing the first set of data, the second set of data, and the third set of data as measurement with an extended Kalman filter; and controlling, by the processor, the vehicle based on the at least two vehicle states.

In various embodiments, the at least two vehicle states include a longitudinal velocity and a lateral velocity.

In various embodiments, the at least two vehicle states further include a vehicle position, a lateral offset, and a lane heading.

In various embodiments, the extended Kalman filter is a six state filter comprising a lateral offset d, a lane heading ψ_{c}, a vehicle heading ψ, a lateral velocity V_{y}, a longitudinal velocity Vₓ, and a yaw rate r.

In various embodiments, the extended Kalman filter is configurable based on an availability of the first set of data, the second set of data, and the third set of data.

In various embodiments, the extended Kalman filter includes control values, wherein the control values includes a lane curvature X, a lateral acceleration a_{y}, a longitudinal acceleration aₓ, and a yaw acceleration.

In various embodiments, the measurements include a lateral offset d, a heading error Δψ, an east velocity V_{E}, a north velocity V_{N}, and a yaw rate r.

In various embodiments, the measurements further include a vehicle heading ψ.

In various embodiments, the method further includes fusing the at least two states with at least two other states determined from a vehicle dynamics model to produce enhanced states, and wherein the controlling is based on the enhanced states.

In various embodiments, the method further includes synchronizing the first set of data, the second set of data, and the third set of data to produce synchronized data, and wherein the processing the first set of data, the second set of data, and the third set of data is based on the synchronized data.

In another embodiment a system includes: a camera configured to sense an environment of the vehicle; an inertial measurement unit configured to sense parameters of the vehicle; a global positioning system configured to sense parameters of the vehicle; and a controller configured to, by a processor, receive a first set of data obtained from the inertial measurement unit, receive a second set of data obtained from the global positioning system, receive a third set of data obtained from the camera, determine at least two vehicle states relative to markings of a lane by processing the first set of data, the second set of data, and the third set of data as measurement with an extended Kalman filter; and control the vehicle based on the at least two vehicle states.

In various embodiments, the at least two vehicle states include a longitudinal velocity and a lateral velocity.

In various embodiments, the at least two vehicle states further include a vehicle heading, a lateral offset, a lane heading and a yaw rate.

In various embodiments, the extended Kalman filter is a six state filter comprising a lateral offset d, a lane heading ψ_{c}, a vehicle heading ψ, a lateral velocity V_{y}, a longitudinal velocity Vₓ, and a yaw rate r.

In various embodiments, the extended Kalman filter is configurable based on an availability of the first set of data, the second set of data, and the third set of data.

In various embodiments, the extended Kalman filter includes control values, wherein the control values includes a lane curvature χ, a lateral acceleration a_{y}, a longitudinal acceleration aₓ, and a yaw acceleration A_{ψ}.

In various embodiments, the measurements include a lateral offset d, a heading error Δψ, a east velocity V_{E}, a north velocity V_{N}, and a yaw rate r.

In various embodiments, the measurements further include a vehicle heading ψ.

In various embodiments, the controller is further configured to fuse the at least two states with at least two other states determined from a vehicle dynamics model to produce enhanced states, and control the vehicle based on the enhanced states.

In various embodiments, the controller is further configured to synchronize the first set of data, the second set of data, and the third set of data to produce synchronized data, and wherein the processing the first set of data, the second set of data, and the third set of data is based on the synchronized data.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating a vehicle having a vehicle state determination system, in accordance with various embodiments;

FIG. 2 is a dataflow diagram illustrating the vehicle state determination system, in accordance with various embodiments; and

FIG. 3 is a flowchart illustrating a method for determining the vehicle state using GPS data and camera data, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

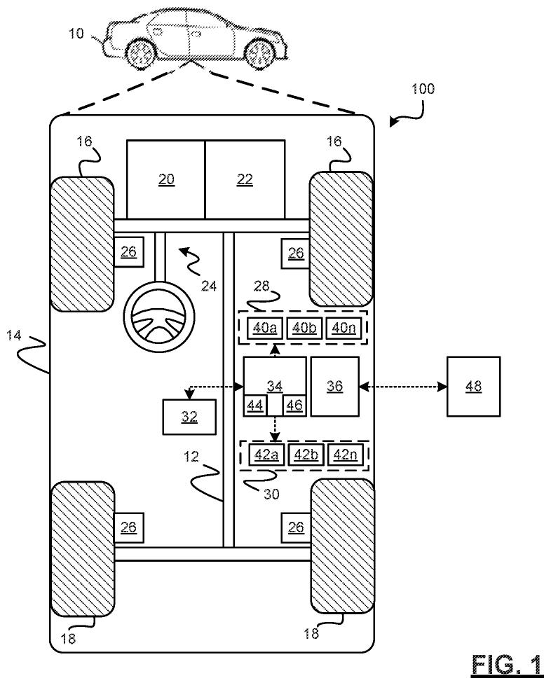

With reference to FIG. 1, a vehicle state determination system shown generally at 100 is associated with a vehicle 10 in accordance with various embodiments. In general, the vehicle state determination system 100 provides a framework for determining a vehicle state, such as a vehicle lateral velocity and longitudinal velocity, using data from a vehicle camera, an IMU, and a global positioning system.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the vehicle state determination system 100 is incorporated into the vehicle 10. The autonomous vehicle 10 is, for example, a vehicle that is automatically controlled to carry passengers from one location to another. For example, the vehicle 10 may be a so-called Level Two, Level Three, Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. As shown, the vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, inertial measurement units, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

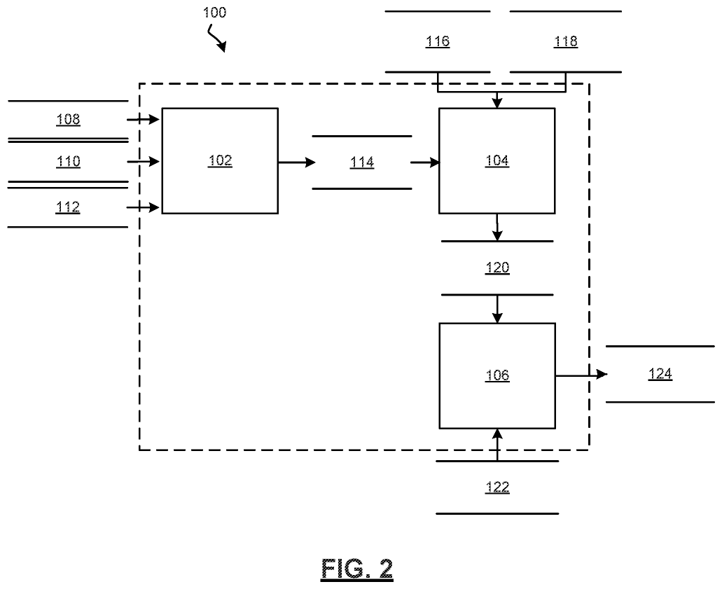

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the autonomous vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

In various embodiments, one or more instructions of the controller 34 are embodied in the vehicle state determination system 100 and, when executed by the processor 44 receive sensor data from the sensor system, determine vehicle state data including vehicle lateral velocity and vehicle longitudinal velocity based on the sensor data, and control the vehicle based on the vehicle lateral velocity and vehicle longitudinal velocity.

With reference now to FIG. 2 and with continued reference to FIG. 1, a dataflow diagram illustrates the vehicle state determination system 100 in accordance with various embodiments, the vehicle state determination system 100 includes a data synchronization module 102, a state determination module 104, and a state fusion module 106. It will be understood that various embodiments of the vehicle state determination system 100 according to the present disclosure may include any number of sub-modules embedded within the controller 34 which may be combined and/or further partitioned to similarly implement systems and methods described herein. Furthermore, inputs to the vehicle state determination system 100 may be received from the sensor system 28, retrieved from the data storage device 32, received from other control modules (not shown) associated with the autonomous vehicle 10, received from the communication system 36, and/or determined/modeled by other sub-modules (not shown) within the controller 34 of FIG. 1. Furthermore, the inputs might also be subjected to preprocessing, such as sub-sampling, noise-reduction, normalization, feature-extraction, missing data reduction, and the like.

In various embodiments, the data synchronization module 102 receives as input IMU data 108, GPS data 110, and/or camera data 112. The data 108-112 includes data that may be derived from values sensed by the sensing devices of the sensor system 28 and/or may include data directly sensed from the sensing devices. For example, the IMU data 108 includes vehicle acceleration data and angular velocity data. The vehicle acceleration data includes vehicle acceleration values aₓₘ, a_{ym}, a_{zm}, which may be provided in each of an x, y, and z axes of a vehicle reference frame where with the vehicle positive x-axis pointing towards a front of the vehicle, the vehicle positive y-axis or pitch axis pointing towards leftward, and the vehicle positive z-axis or yaw axis pointing upward. The angular velocity data includes angular velocity values ωₓ, ω_{y}, ω_{z} which may be provide in each of the x, y, an x axis of the vehicle reference frame. Angular accelerations Aₓ, A_{y}, A_{z} can be obtained by numerical derivation of the angular velocities ωₓ, ω_{y}, ω_{z}.

The GPS data 110 includes vehicle velocity data, geospatial position data, and course data. The vehicle velocity data includes vehicle velocities V_{E}, V_{N}, and V_{U} which may be provided with reference to an ENU (East-North-Up) reference frame. The geospatial position data includes geospatial position may include latitude, longitude, and/or altitude of the vehicle for example at the antenna A in the ENU frame. The course data includes a vehicle course angle γ which provides a direction of the vehicle that corresponds to the velocity vector.

The camera data 112 includes lane data. The lane data includes a lateral offset d, a lane heading error Δψ, and curvature of the path χ at point C.

In various embodiments, the data synchronization module 102 pre-processes the received data 108-112 and synchronizes the pre-processed data with respect to time. For example, the data synchronization module 102 checks signal validity, selects valid signals from redundant sensors, and executes low pass filtering and bias removal to generate unbiased, filtered values. The data synchronization module 102 then synchronizes the unbiased, filtered values using a global time clock (e.g., at 100 Hz, or other time) to produce synchronized data 114.

In various embodiments, the state determination module 104 receives as input the synchronized data 114, estimated vehicle roll angle data 116, and estimated vehicle pitch angle data 118. In various embodiments, the estimated vehicle roll angle data 116 and/or the estimated vehicle pitch angle data 118 is received when the data is determined to be valid. For example, pitch angle data may be valid for use when steady state motion around the pitch axis is determined. In another example, roll angle data may be valid for use when steady state motion around the roll axis is determined.

The state determination module 104 performs a six state extended Kalman filter on the received data to estimate vehicle states with respect to lane markings and to generate vehicle state data 120 based thereon. The vehicle states include a two-dimensional vehicle velocity, a vehicle heading, vehicle yaw rate, a lateral offset, and a lane heading.

In various embodiments, the vehicle states are estimated based on motion kinematics and are not dependent upon a vehicle dynamic model. For example, given the state space model:

\dot{x}=f(x,u)+w,

z=h(x)+v,

where w represents process noise, and v represents observation noise, the state determination module 104 recursively executes the model based on a series of measurements z which are the observed data inputs (e.g., from the IMU, the GPS, and the camera) over time to produce the state variables x given control variables u (e.g., from the IMU, and the camera).

In various embodiments, the measurements z include:

z=[d, Δψ, V_{E}, V_{N}, r]′ or

z=[d, Δψ, V_{E}, V_{N}, r, ψ]′,

depending on the availability of the estimated angle data 116, 118 to provide the vehicle heading ψ.

In various embodiments, the state x variables include:

x=[d, ψc, ψ, Vₓ, V_{y}, r]′

where

$$\dot{d} = {V}_{y} + ( {V}_{x} + dr ) tan Δψ ,$$

$${\dot{ψ}}_{C} = χ \frac{{V}_{x} + dr}{cos Δψ} ,$$

$$\dot{ψ} = r ,$$

$${\dot{V}}_{x} = {a}_{x} + r {V}_{y} ,$$

$${\dot{V}}_{y} = {a}_{y} - r {V}_{x} ,$$

$$\dot{r} = {A}_{ψ} ,$$

and where ψ_{c} is the lane heading and. Δψ≡ψ−ψ_{c}. In various embodiments, the control variables include:

u=[χ, aₓ, a_{y}, A_{ψ}]′

where aₓ, a_{y} are the acceleration values of the IMU data 108 compensated for gravity, and A₁₀₄ is the yaw acceleration.

In various embodiments, the state fusion module 106 receives the vehicle state data 120 generated by the state determination module 104 and model data 122 In various embodiments, the state fusion module 106 receives the vehicle state data 120 generated by the state determination module 104 and model data 122 such as roll and pitch parameters, road surface friction coefficient data, angular velocity data, road wheel angle data for the vehicle 10. The state fusion module 106 fuses the lateral velocity and the longitudinal velocity from the vehicle state data 120 with the model data 122 to produce enhanced state data 124 including enhanced lateral velocity and longitudinal velocity.

For example, the state fusion module 106 uses a dynamical vehicle model (for example, a Bicycle model) that considers the lateral velocity and the longitudinal velocity from the vehicle state data 120 as pseudo measurements. In various embodiments, a standard extended Kalman filter can be used to generate the values. For example,

For example, given the state space model:

\dot{x}=f(x,u)+w,

z=h(x)+v,

in various embodiments, the measurements include:

V_{y}=V_{y}

r=ω_{z}

μ=μₘ,

where μₘ represents an estimate or measurement of the road surface friction coefficient.

The state variables include:

x=[V_{y}, r, μ]′.

The control variables include:

u=[δ_{F}, δ_{R}]′

δ_{F} and δ_{R} represent the front and rear road wheel angles.

The enhanced lateral velocity and longitudinal velocity may be then used by other modules of the controller 34 to provide improved control of the operation of the vehicle 10.

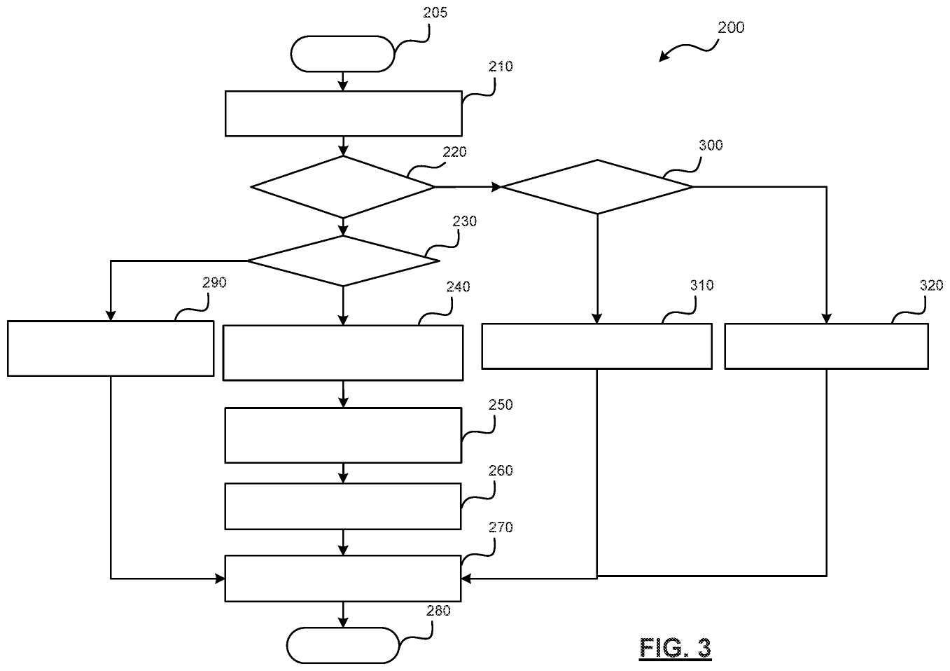

Referring now to FIG. 3 and with continued reference to FIGS. 1-2, a flowchart illustrates a control method 300 that can be performed by the vehicle state determination system 100 of FIGS. 1 and 2 in accordance with the present disclosure. As can be appreciated in light of the disclosure, the order of operation within the method 300 is not limited to the sequential execution as illustrated in FIG. 3 but may be performed in one or more varying orders as applicable and in accordance with the present disclosure. In various embodiments, the method 300 can be scheduled to run based on one or more predetermined events, and/or can run continuously during operation of the vehicle 10.

In one embodiment, the method may begin at 305. IMU data 108 is received at 210. Thereafter, it is determined whether the GPS data 110 is available at 220. When GPS data 110 is available at 220, it is determined whether the camera data 112 is available at 230. When the camera data 112 is available at 230, the received data 108, 110, and 112 is synchronized at 240, and the state data is determined using motion kinematics through recursive execution of the six states EKF as discussed above at 250. The state data is fused with state data modeled from vehicle dynamics to provide enhanced state data at 260. Thereafter, the vehicle 10 is controlled based on the enhanced state data at 270. The method may end at 280.

If, however, GPS data 110 is available at 220 and camera data 112 is not available at 230, the IMU data 108 and the GPS data 110 is fused at 290 to provide state data. Thereafter, the vehicle 10 is controlled based on the fused data at 270. The method may end at 280.

If, however, GPS data 110 is not available at 220 but camera data 112 is available at 300, then the IMU data 108 and the camera data 112 are fused at 310 to provide state data. Thereafter, the vehicle 10 is controlled based on the state data at 270. The method may end at 280.

If, however, GPS data 110 is not available at 220 and camera data 112 is not available at 300, then the IMU data is used along with a vehicle dynamics model to produce the state data at 320. Thereafter, the vehicle 10 is controlled based on the state data at 270. The method may end at 280.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of controlling a vehicle, comprising:
receiving, by a processor, a first set of data obtained from an inertial measurement unit of the vehicle;
receiving, by the processor, a second set of data obtained from a global positioning system of the vehicle;
receiving, by the processor, a third set of data obtained from a camera of the vehicle;
determining, by the processor, at least two vehicle states relative to markings of a lane by processing the first set of data, the second set of data, and the third set of data as measurement with an extended Kalman filter; and
controlling, by the processor, the vehicle based on the at least two vehicle states.

2. The method of claim 1, wherein the at least two vehicle states include a longitudinal velocity and a lateral velocity.

3. The method of claim 2, wherein the at least two vehicle states further include a vehicle position, a lateral offset, and a lane heading.

4. The method of claim 1, wherein the extended Kalman filter is a six state filter comprising a lateral offset d, a lane heading ψ_{c}, a vehicle heading ψ, a lateral velocity V_{y}, a longitudinal velocity Vₓ, and a yaw rate r.

5. The method of claim 4, wherein the extended Kalman filter is configurable based on an availability of the first set of data, the second set of data, and the third set of data.

6. The method of claim 4, wherein the extended Kalman filter includes control values, wherein the control values includes a lane curvature χ, a lateral acceleration a_{y}, a longitudinal acceleration aₓ, and a yaw acceleration A_{ψ}.

7. The method of claim 6, wherein the measurements include a lateral offset d, a heading error Δψ, a east velocity V_{E}, a north velocity V_{N}, and a yaw rate r.

8. The method of claim 7, wherein the measurements further include a vehicle heading ψ.

9. The method of claim 1, further comprising fusing the at least two states with at least two other states determined from a vehicle dynamics model to produce enhanced states, and wherein the controlling is based on the enhanced states.

10. The method of claim 1, further comprising synchronizing the first set of data, the second set of data, and the third set of data to produce synchronized data, and wherein the processing the first set of data, the second set of data, and the third set of data is based on the synchronized data.

11. A system for controlling a vehicle, comprising:
a camera configured to sense an environment of the vehicle;
an inertial measurement unit configured to sense parameters of the vehicle;
a global positioning system configured to sense parameters of the vehicle; and
a controller configured to, by a processor, receive a first set of data obtained from the inertial measurement unit, receive a second set of data obtained from the global positioning system, receive a third set of data obtained from the camera, determine at least two vehicle states relative to markings of a lane by processing the first set of data, the second set of data, and the third set of data as measurement with an extended Kalman filter; and control the vehicle based on the at least two vehicle states.

12. The system of claim 11, wherein the at least two vehicle states include a longitudinal velocity and a lateral velocity.

13. The system of claim 12, wherein the at least two vehicle states further include a vehicle heading, a lateral offset, a lane heading and a yaw rate.

14. The system of claim 11, wherein the extended Kalman filter is a six state filter comprising a lateral offset d, a lane heading ψ_{c}, a vehicle heading ψ, a lateral velocity V_{y}, a longitudinal velocity Vₓ, and a yaw rate r.

15. The system of claim 14, wherein the extended Kalman filter is configurable based on an availability of the first set of data, the second set of data, and the third set of data.

16. The system of claim 14, wherein the extended Kalman filter includes control values, wherein the control values includes a lane curvature χ, a lateral acceleration a_{y}, a longitudinal acceleration aₓ, and a yaw acceleration A_{ψ}.

17. The system of claim 16, wherein the measurements include a lateral offset d, a heading error Δψ, an east velocity V_{E}, a north velocity V_{N}, and a yaw rate r.

18. The system of claim 17, wherein the measurements further include a vehicle heading ψ.

19. The system of claim 11, wherein the controller is further configured to fuse the at least two states with at least two other states determined from a vehicle dynamics model to produce enhanced states, and control the vehicle based on the enhanced states.

20. The system of claim 11, wherein the controller is further configured to synchronize the first set of data, the second set of data, and the third set of data to produce synchronized data, and wherein the processing the first set of data, the second set of data, and the third set of data is based on the synchronized data.
